(19) United States
(12) Patent Application Publication
(10) Pub. No.: US 2026/0270015 A1
(43) Pub. Date: Sep. 10, 2026

(54) CONTROL MESSAGE REQUESTING HYBRID AUTOMATIC REPEAT REQUEST (HARQ) PROCESS STATE

(71) Applicant: QUALCOMM Incorporated, San Diego, CA (US)

(72) Inventors: Ran Berliner, Kfar-Aviv (IL); Konstantin Kupershlak, Ramat Gan (IL); Amir Klein, Herzlya (IL); Shay Landis, Hod Hasharon (IL); Eitan Yerushalmi, Tel Aviv (IL); Amit Bar-or Tillinger, Tel-Aviv (IL)

(21) Appl. No.: 19/071,244

(22) Filed: Mar. 5, 2025

(51) Int. Cl. H04L 5/00; H04L 1/00; H04L 1/1812; H04W 72/231

(52) U.S. Cl. CPC H04L 5/0053; H04L 1/0003; H04L 1/1812; H04W 72/231

(57) ABSTRACT

In some implementations, a user equipment (UE), transmits a first uplink message indicating an acknowledgement (ACK) or a negative acknowledgement (NACK) associated with receiving a transmission. The UE receives downlink message including a control message indicating a configuration for the UE to provide a hybrid automatic repeat request (HARQ) state based on an ambiguity associated with the first uplink message indicating the ACK or the NACK, where the UE receives the downlink message without a physical downlink shared channel (PDSCH) allocation. The HARQ status indicates a decoding state, a new data indicator, or both.

### TECHNICAL FIELD

Aspects of the present disclosure generally relate to wireless communication and specifically relate to techniques, apparatuses, and methods associated with facilitating an efficient and accurate identification of a hybrid automatic repeat request status or state.

### INTRODUCTION

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In some wireless communication systems, a hybrid automatic repeat request (HARQ) procedure between network node and user equipment (UE) may be implemented to ensure reliable transmission. During the HARQ procedure, the network node may transmit encoded data packets and the UE may send feedback to the network node, such as an acknowledgement (ACK) or negative acknowledgement (NACK) message, indicating whether the UE received and successfully decoded the data. In some cases, the network node may be uncertain of whether the UE transmitted an ACK or a NACK.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some wireless communication systems, a hybrid automatic repeat request (HARQ) process may be implemented. The HARQ is a communication protocol that enhances data transmission reliability by allowing a user equipment (UE), such as a wireless device or wireless node, to detect and correct errors in data received from a network node, such as a base station, through a combination of retransmissions and error correction codes. In particular, the UE may send feedback to the network node, such as an acknowledgement (ACK) or negative acknowledgement (NACK) message, to indicate whether the UE received and decoded data correctly. The network node may retransmit data when the UE indicates a NACK. However, in some cases, the network node may be uncertain of whether the UE transmitted an ACK or a NACK. In such cases, the network node may extend the HARQ process to query for the ambiguous HARQ process state. In addition to latencies, inefficiencies may result at the network node and/or at the UE, such as increased power consumption and inefficient usage of resources via the extended process.

Using the techniques described herein, to efficiently identify the status of the HARQ process, such as whether the UE successfully decoded the last transmission and/or the initial transmission correctly, the network node may communicate a downlink control message requesting the HARQ process status. For example, rather than retransmitting to the UE over a downlink shared channel, such as a physical downlink shared channel (PDSCH), for the UE to provide another NACK or ACK to confirm the previous ACK or NACK, the control message is communicated over the downlink control channel. The control message may be a downlink control information (DCI) message that indicates a request for the HARQ process status. The UE may respond with an ACK or NACK communicated over an uplink control channel, such as physical uplink control channel (PUCCH), indicating whether the UE correctly decoded the previous transmission. The UE may additionally provide an indication of whether the UE correctly decoded the initial or first transmission, for example, that indicates transport block size (TBS) for special modulation and coding scheme (MCS).

For example, a DCI message, such as a DCI 1_0 PDCCH order command, may be used to initiate a HARQ process state report, for example, a report similar to one used for a random access channel (RACH) order. Additionally, or alternatively, to the DCI 1_0 PDCCH order command, a new DCI type may be used. The DCI may include an identifier bit. The DCI may be padded over existing DCIs, for example, to maintain the same DCI bit size. Additionally, or alternatively, to the DCI 1_0 PDCCH order and the new DCI type, a dedicated DCI bit may be used. For example, a bit may be added to existing DCIs that indicates a request for the HARQ process status report. In some examples, another bit may be added to indicate a request for a new data indicator (NDI) report. An NDI polarity (0 or 1) may indicate whether the initial transmission was successfully decoded. The bits may be enabled by a radio resource control (RRC) configuration.

Accordingly, using the techniques described herein, a HARQ process status may be communicated without inefficiently using the downlink or uplink shared channels that may otherwise be used for communicating data. The techniques described herein also facilitate communicating initial transmission decoding status, where the initial transmission may indicate a special MCS for retransmissions. The network node may not inefficiently retransmit with the special MCS in a retransmission upon determining that the initial transmission indicating the MCS, was not successfully decoded. In this manner, the HARQ process status may be accurately identified with confidence while reducing inefficient usage of resources of the downlink or uplink shared channel.

In one aspect of the disclosure, an apparatus for wireless communication at a UE includes one or more memories comprising instructions, and one or more processors coupled with the one or more memories and individually or collectively operable to execute the instructions to cause the apparatus to transmit a first uplink message indicating an ACK or a NACK associated with receiving a transmission. The one or more processors are individually or collectively further operable to execute the instructions to cause the apparatus to receive a downlink message comprising a control message indicating a configuration for the apparatus to provide a HARQ state based on an ambiguity associated with the first uplink message indicating the ACK or the NACK, where the UE receives the downlink message without a PDSCH allocation.

In another aspect of the disclosure, a method for wireless communication performed at a UE includes transmitting a first uplink message indicating an ACK or a NACK associated with receiving a transmission. The method includes receiving a downlink message comprising a control message indicating a configuration for the UE to provide a HARQ state based on an ambiguity associated with the first uplink message indicating the ACK or the NACK, where the UE receives the downlink message without a PDSCH allocation.

In some aspects of the apparatus performed at the UE and the method described herein, the HARQ state indicates a decoding state of a last transmission, a decoding state of the transmission, or both, where the transmission is indicative of a transport block size used for subsequent transmissions. In some aspects, the ambiguity is associated with a confidence level of the uplink message indicating the ACK or the NACK below a threshold confidence level. In some aspects, to the UE transmits a second uplink message indicating the HARQ state, the second uplink message communicated over an uplink control channel. In some aspects, the UE receives a second downlink message including a retransmission, where the transmission is associated with a redundancy version zero (RV0) and the retransmission is associated with a redundancy version two (RV2) based on the downlink message including the control message. In some aspects, the second downlink message includes an indication of a MCS based on a polarity of an NDI in a second uplink message from the UE. In some aspects, the downlink message includes a DCI message communicated over a downlink control channel. In some aspects, the control message includes an identifier bit associated with the HARQ state. In some aspects, the identifier bit is a dedicated bit that is padded based on other control messages.

In an additional aspect of the disclosure, an apparatus for wireless communication performed at a network node includes one or more memories comprising instructions, and one or more processors coupled with the one or more memories and individually or collectively operable to execute the instructions to cause the apparatus to receive a first uplink message indicating an ACK or a NACK associated with receiving the transmission. The one or more processors are individually or collectively further operable to execute the instructions to cause the apparatus to transmit a downlink message including a control message indicating a configuration for a UE to provide a HARQ state based on an ambiguity associated with the first uplink message indicating the ACK or the NACK, where the UE receives the downlink message without a PDSCH allocation.

In another aspect of this disclosure, a method for wireless communication at a network node includes receiving a first uplink message indicating an ACK or a NACK associated with receiving a transmission. The method includes transmitting a downlink message including a control message indicating a configuration for a UE to provide a HARQ state based on an ambiguity associated with the first uplink message indicating the ACK or the NACK, where the UE receives the downlink message without PDSCH allocation.

In some aspects of the apparatus performed at the network node and the method described herein, the HARQ state indicates a decoding state of a last transmission, a decoding state of the transmission, or both, where the transmission is indicative of a transport block size used for subsequent transmissions. In some aspects, the ambiguity is associated with a confidence level of the uplink message indicating the ACK or the NACK below a threshold confidence level. In some aspects, the network node receives a second uplink message indicating the HARQ state, the second uplink message communicated over an uplink control channel. In some aspects, the network node receives a second downlink message including a retransmission, where the transmission is associated with a redundancy version zero (RV0) and the retransmission is associated with a redundancy version two (RV2) based on the downlink message including the control message. In some aspects, the second downlink message includes an indication of a MCS based on a polarity of an NDI in a second uplink message from the UE. In some aspects, the downlink message includes a DCI message communicated over a downlink control channel. In some aspects, the control message includes an identifier bit associated with the HARQ state. In some aspects, the identifier bit is a dedicated bit that is padded based on other control messages.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example of physical channels and reference signals in a wireless network, in accordance with the present disclosure.

FIG. 3 is a diagram of an example process flow associated with a hybrid automatic repeat request state query, in accordance with the present disclosure.

FIG. 4 is a diagram illustrating an example process performed, for example, at a user equipment or an apparatus of a user equipment, in accordance with the present disclosure.

FIG. 5 is a diagram illustrating an example process performed, for example, at a network node or an apparatus of a network node, in accordance with the present disclosure.

FIG. 6 is a diagram of an example apparatus for wireless communication, in accordance with the present disclosure.

FIG. 7 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a wireless node, such as a user equipment (UE), may communicate with a network node to carry out one or more tasks, and often, the wireless node may provide feedback information to the network node. The feedback information may include hybrid automatic repeat request (HARQ) feedback and/or a feedback codebook. In the context of HARQ feedback information, “codebook” refers to a set of one or more or a matrix of one or more feedback indications, such as acknowledgement (ACK) or negative ACK (NACK) indications, that may be transmitted via a single uplink transmission. In some cases, the network node may support HARQ feedback transmissions. A HARQ feedback transmission may include a feedback message that the wireless node is to transmit, for example, to a network node, to provide feedback regarding downlink data transmissions. As used herein, a codebook may be a sequence of bits, which may be constructed using ACK/NACK feedback associated with multiple downlink communications that are received by a network entity during a feedback window. A codebook may include one or more codewords. A codeword may include a message or communication. For example, a codeword may include one or more ACK/NACK feedback indications, such as a sequence of one or more HARQ ACK bit values and/or HARQ NACK bit values. As used herein, “ambiguity” refers to certainty or a confidence level that is below a threshold confidence level. For example, as discussed herein, a network node may determine that a feedback indicating a NACK or an ACK is ambiguous, such that the network node is unsure of whether the feedback message indicates a NACK or an ACK. That is, the network node cannot determine with confidence above the threshold level of confidence, that the received feedback indicating the ACK or the NACK is truly an ACK or NACK.

The network node may retransmit data when the wireless node transmits HARQ feedback indicating a NACK. However, in some cases, the network node may be uncertain of whether the network node received an ACK or a NACK. In such cases, the network node may extend the HARQ process to query for the ambiguous HARQ process state. In addition to latencies, increased power consumption and other inefficiencies may result at the network node and/or at the wireless node due to the extended process.

For example, the network node may inefficiently allocate a portion of a downlink shared channel, such as a single resource block (RB) of the downlink shared channel to retransmit. In particular, when the network node is uncertain of whether the network node received an ACK or a NACK, the network node may allocate a downlink shared channel, such as a physical downlink shared channel (PDSCH), for a retransmission in a single RB to trigger HARQ feedback from the wireless node. However, the downlink shared channel retransmission may inefficiently use downlink capacity and UE power for a decoding attempt that will not change the previous decoding result. For example, the downlink shared channel retransmission may operate as a “dummy” downlink shared channel transmission used to query the UE for another indication of the HARQ process decoding state.

In such cases, when the network entity retransmits over the downlink shared channel, the retransmission for querying the HARQ status does not contribute to an incremental redundancy (IR) scheme and reduces HARQ performance. In particular, the IR scheme for transmissions may include an order of redundancy version zero (RV0), redundancy version two (RV2), redundancy version three (RV3), and redundancy version one (RV1) for reliable transmissions. The redundancy version zero (RV0) is used for the initial transmission and the redundancy version two (RV2) is used for the “dummy” retransmission in the single RB, resulting in redundancy version three (RV3) being used for the subsequent retransmission. Thus, the single RB allocation does not contribute to the incremental redundancy scheme, reducing the HARQ performance.

The retransmission for querying the HARQ process status may also include a special modulation and coding scheme (MCS). However, the network node may be unaware of whether the wireless node successfully decoded the initial transmission, which may indicate an explicit MCS value, indicative of a transport block size (TBS). Thus, using special MCS in retransmissions that reference the MCS indicated in the initial transmission when the wireless node failed to decode the initial transmission, may be a waste of cell resources. That is, the wireless node may be unable to decode or determine the TBS indicated by the special MCS. Thus, the wireless node send a NACK in response to a retransmission indicating the special MCS. The network node may continue to send the retransmissions indicating special MCS in response to the NACKs, up to a maximum or threshold quantity of retransmissions. For example, the multiple retransmissions may effectively result in a “radio link control (RLC) hole,” where the network node sends multiple retransmissions and the wireless node keeps responding with the NACK. In such cases, the wireless node may send a fake ACK to terminate the HARQ process retransmissions, for example, after the threshold quantity of retransmissions or NACKs. The multiple NACKs may result in packet latencies for the RLC layer to detect and initiate retransmitting the missing packet in RLC (when RLC acknowledge mode (RLC-AM) is used).

Various aspects generally relate to efficiently and accurately communicating a HARQ process state. Some aspects more specifically relate to communicating whether the wireless node properly decoded the previous and/or initial transmission correctly. For example, the HARQ process status may be accurately identified without allocating a portion of the downlink shared channel, such as the PDSCH, for data. Rather than the network node retransmitting the transmission to a wireless node, such as a UE, in a single RB over the downlink shared channel for the purpose of the wireless node transmitting another NACK or ACK confirming the previous ACK or NACK to remove HARQ status ambiguity, a control message may be communicated to the wireless node over a downlink control channel requesting the HARQ process state. For example, a downlink control information (DCI) message may define or indicate a PDSCH HARQ process state query without PDSCH allocation. For example, the DCI communicated over a physical downlink control channel (PDCCH) may include a physical uplink control channel (PUCCH) order. The PUCCH order may command the wireless node to indicate the HARQ process state via the PUCCH. In response, the wireless node may transmit an indication of the decoding or cyclic redundancy check (CRC) state of the HARQ process, and optionally a new data indicator (NDI) bit polarity.

For example, after receiving a message including the PUCCH order, the wireless node may respond with another ACK or NACK, indicating whether the wireless node correctly decoded the previous transmission. The wireless node may additionally provide an indication of whether the wireless node correctly decoded the initial or first transmission, which indicates the TBS for special MCS. Thus, the network node has knowledge that the initial PDSCH transmission was not decoded by the wireless node, and thus, the network node should no longer send retransmissions with special MCS. In this manner, the network node may avoid sending multiple retransmissions where the wireless node keeps responding with the NACK (in an “RLC hole”), reducing processing inefficiencies and increasing latencies resulting from the cycle of multiple retransmissions and NACKs. Moreover, the network node requesting the HARQ process state query via the PUCCH order, without a PDSCH allocation, may increase cell resources efficiency. For example, the PDSCH may be allocated for other operations since the network node no longer allocates the PDSCH to send the dummy PDSCH transmission for the HARQ process CRC state.

For example, a DCI message, such as a DCI 1_0 PDCCH order or a control command querying the HARQ process state, may be transmitted over the physical downlink shared channel (PDSCH) to initiate a HARQ process state report, which may be a report similar to one used for a random access channel (RACH) order. Additionally, or alternatively, to the DCI 1_0 PDCCH order, a new DCI type may be used. The DCI may include an identifier bit for the particular UE and network node connection. The DCI may be padded over existing DCIs, for example, to maintain the same DCI bit size. Additionally, or alternatively, to the DCI 1_0 PDCCH order and the new DCI type, a dedicated DCI bit may be used. For example, a bit may be added to existing DCIs that indicates a request for a HARQ process status report. In some examples, another bit may be added for an NDI report indicating an NDI polarity. The NDI polarity, such as a 0 or 1, may indicate whether the initial transmission was successfully decoded. In some examples, the bits may be enabled by a radio resource control (RRC) configuration.

Particular aspects of the subject matter described in this disclosure can be implemented to realize one or more of the following potential advantages. In some examples, by communicating a control message requesting the PDSCH HARQ process state without a downlink shared channel allocation, the described techniques may be used to facilitate efficiently and accurately identify the HARQ state while allowing the downlink shared channel to be used for other data communication. This may reduce unnecessarily using shared channel resources since the retransmission over the shared channel will likely not change the decoding status at the UE. As another example, using the downlink shared channel for retransmissions addressing decoding failures, for example, rather than a single RB transmission used to trigger a response from the UE, may facilitate in maintaining the IR of the RV associated with the retransmissions, improving the likelihood of successful decoding.

Additionally, by including an NDI polarity in the feedback in addition to the NACK/ACK indication, the network node may determine that the UE did not successfully decode the initial transmission, which included a special MCS. Thus, the network node may determine that additional indications of the special MCS in subsequent retransmissions may be inefficient or not useful to the UE. In some aspects, by requesting the HARQ process state via a downlink control message that is communicated over a downlink channel, such as the PDCCH, the network node and/or the UE may conserve processing resources, computing resources, and/or memory resources that may otherwise be used in inefficient retransmission of single RB to trigger a UE response and result in a non-IR scheme, among other examples.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

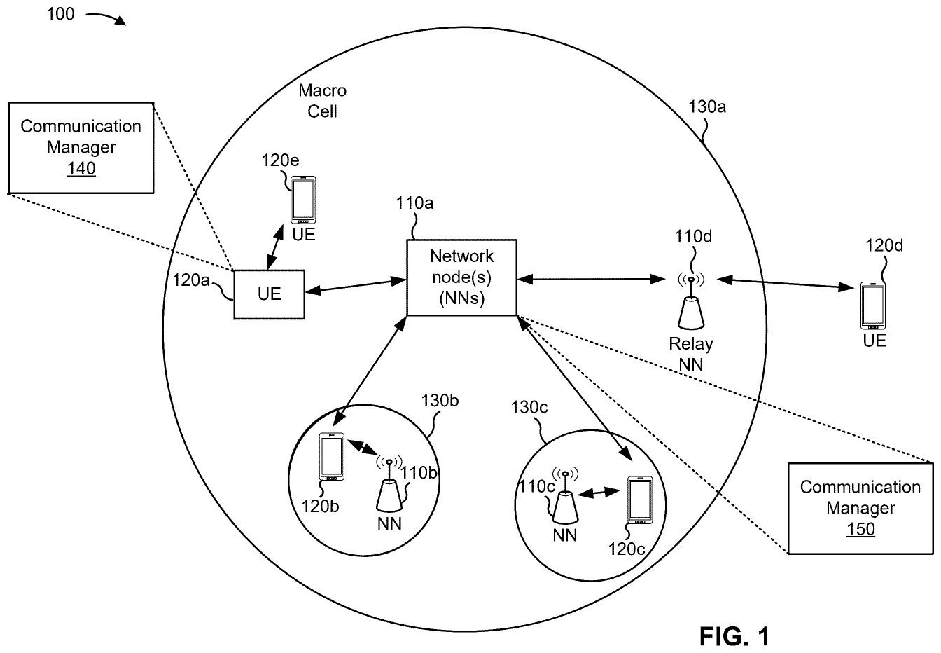

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more PUCCHs, and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, RBs, and/or resource elements (REs)), and/or spatial domain resources (particular transmit directions and/or beam parameters). Frequency domain resources of some bands may be subdivided into bandwidth parts (BWPs). A BWP may be a continuous block of frequency domain resources (for example, a continuous block of RBs) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

As discussed herein, the network node 110 (network node 110a, 110b, 110c, and/or 110d) may communicate, via the communication manager 150, a DCI message to the UE 120 (UE 120a, 120b, 120c, 120d, and/or 120e). For example, the UE 120 may receive the DCI message via the communication manager 140 of the UE 120. The DCI may indicate a request for a HARQ process state query that is initiated by a PUCCH order. The DCI may be communicated without PDSCH allocation. For example, the DCI may be communicated over the PDCCH.

For example, in some aspects, the UE 120 may include a communication manager 140. As described in more detail elsewhere herein, the communication manager 140 may transmit a first uplink message indicating an ACK or a NACK associated with receiving a transmission; and receive a downlink message comprising a control message indicating a configuration for the apparatus to provide a HARQ state based on an ambiguity associated with the first uplink message indicating the ACK or the NACK, where the UE receives the downlink message without a PDSCH allocation. Additionally, or alternatively, the communication manager 140 may perform one or more other operations described herein.

In some aspects, the network node 110 may include a communication manager 150. As described in more detail elsewhere herein, the communication manager 150 may receive a first uplink message indicating an ACK or a NACK associated with receiving a transmission; and transmit a downlink message including a control message indicating a configuration for a UE to provide a HARQ state based on an ambiguity associated with the first uplink message indicating the ACK or the NACK, where the UE receives the downlink message without PDSCH allocation. Additionally, or alternatively, the communication manager 150 may perform one or more other operations described herein.

As indicated above, FIG. 1 is provided as an example. Other examples may differ from what is described with regard to FIG. 1.

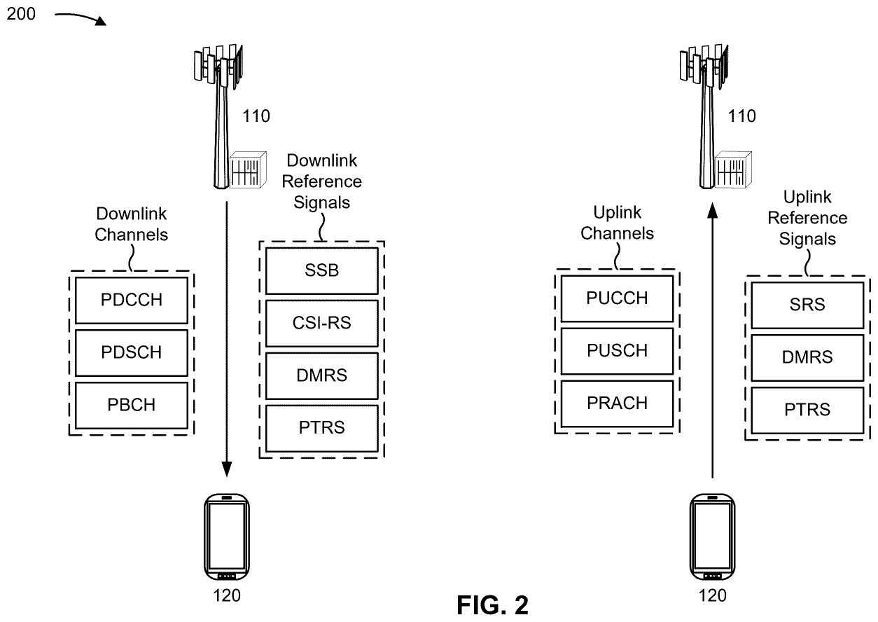

FIG. 2 is a diagram illustrating an example 200 of physical channels and reference signals in a wireless network, in accordance with the present disclosure. As shown in FIG. 2, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a physical broadcast channel (PBCH) that carries system information, among other examples. In some aspects, PDSCH communications may be scheduled by PDCCH communications. As further shown, an uplink channel may include a PUCCH that carries UCI, a PUSCH that carries uplink data, or a PRACH used for initial network access, among other examples. In some aspects, the UE 120 may transmit ACK or NACK feedback or information in UCI on the PUCCH and/or the PUSCH. The feedback may be HARQ feedback for data transmitted via the PDSCH or another downlink channel.

As further shown, a downlink reference signal may include a synchronization signal block (SSB), a CSI-RS, a DMRS, a positioning reference signal (PRS), or a phase tracking reference signal (PTRS), among other examples. As also shown, an uplink reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation, such as for downlink CSI acquisition, which may be used for scheduling, link adaptation, or beam management, among other examples. The network node 110 may configure a set of CSI-RSs for the UE 120, and the UE 120 may measure the configured set of CSI-RSs. Based on the measurements, the UE 120 may perform channel estimation and may report channel estimation parameters to the network node 110, for example, in a CSI report, such as a CQI, a precoding matrix indicator (PMI), a CSI-RS resource indicator (CRI), a layer indicator (LI), a rank indicator (RI), or an RSRP, among other examples. The network node 110 may use the CSI report to select transmission parameters for downlink communications to the UE 120, such as a number or rank of transmission layers, a precoding matrix, an MCS, or a refined downlink beam, such as using a beam refinement procedure or a beam management procedure, among other examples.

A DMRS may carry information used to estimate a radio channel for demodulation of an associated physical channel, such as PDCCH, PDSCH, PBCH, PUCCH, or PUSCH. The design and mapping of a DMRS may be specific to a physical channel for which the DMRS is used for estimation. DMRSs are UE-specific, can be beamformed, can be confined in a scheduled resource for example, rather than transmitted on a wideband, and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications on the PDSCH and uplink communications on the PUSCH.

A PRS may carry information used to enable timing or ranging measurements of the UE 120 based on signals transmitted by the network node 110 to improve observed time difference of arrival (OTDOA) positioning performance. For example, a PRS may be a pseudo-random quadrature phase shift keying (QPSK) sequence mapped in diagonal patterns with shifts in frequency and time to avoid collision with cell-specific reference signals and control channels, such as a PDCCH. In general, a PRS may be designed to improve detectability by the UE 120, which may need to detect downlink signals from multiple neighboring network nodes in order to perform OTDOA-based positioning. Accordingly, the UE 120 may receive a PRS from multiple cells, such as, a reference cell and one or more neighbor cells, and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based on the measurements, and may use the SRS measurements to configure communications with the UE 120.

The UE 120 and the network node 110 may support retransmissions of data to increase the likelihood that data is received successfully. HARQ feedback is one technique for increasing the likelihood that data is received correctly via a communication link or channel. HARQ may include a combination of error detection using a CRC, forward error correction (FEC), and retransmission, such as an automatic repeat request (ARQ). HARQ may improve throughput at the MAC layer in relatively poor radio conditions, such as low signal-to-noise ratio conditions. In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UE 120 may receive downlink signaling from the network node 110. The UE 120 may transmit feedback messages for the downlink signaling. For example, the UE 120 may transmit a feedback codebook, such as a sequence of bits that indicate feedback for one or multiple downlink transmissions. The feedback codebook may include a HARQ ACK or NACK codebook including feedback bits indicating ACK or NACK information for the received downlink signaling. The UE 120 may transmit the feedback, such as the feedback codebook, via an uplink channel, such as the PUCCH.

As indicated above, FIG. 2 is provided as an example. Other examples may differ from what is described with regard to FIG. 2.

In some cases, the network node 110 may transmit a new transmission to the UE 120 as part of a HARQ process procedure. Generally, the HARQ process is procedure that ensures reliable data transmission between entities, such as the network node 110 and the UE 120. The process combines FEC and ARQ to correct errors and retransmit data as needed. To briefly summarize, the process may involve the network node 110 transmitting encoded data packets to the UE 120 that are protected by error correction codes to correct errors during the transmission. The UE may receive the transmission and check for errors by performing a CRC. The transmission is successfully decoded by the UE 120 when the CRC indicates no errors and the transmission fails decoding if errors are detected. The UE 120 may send a feedback message to the network node 110 indicating an ACK when the transmission is successfully decoded and a NACK when the transmission fails, such as when errors are detected. When the network node 110 receives the message indicating the NACK, the network node 110 may retransmit the same data packets or a portion of the packets to the UE 120. Moreover, IR may be applied to the retransmission, where the retransmission includes additional redundancy bits rather than the entire original packet.

The network node 110 may send a new transmission over the PDSCH with a first redundancy version zero (RV0), an MCS index of 22, and a HARQ process identifier (ID) (HARQ #5) in 273 RBs, corresponding to a TBS of 37 kilobits (K bits). The MCS 22 may correspond to a specific combination of modulation and coding rate used for data transmission, and the MCS corresponds to a TBS index (TBSI) that impacts the amount of data sent.

The UE 120 may receive the transmission and perform a CRC check, determining that the CRC failed, such as when a decoding failure occurs. Accordingly, the UE 120 may transmit a feedback message over the PUSCH indicating a NACK, requesting a retransmission. The network node 110 may determine that the feedback is ambiguous, such that the network node 110 is unsure of whether the feedback message indicates a NACK. For example, the level of confidence that the network node 110 has of the feedback message indicating an ACK or NACK may be less than a threshold level of confidence.

Accordingly, in some cases, the network node 110 may send a retransmission over the PDSCH for the purpose of receiving another ACK or NACK to confirm and remove ambiguity, resulting in inefficiencies described herein. The retransmission may be transmitted in a single RB (rather than the 273 RB) since the purpose of the retransmission is to confirm whether the feedback from the UE indicated an ACK or a NACK, for example, with a level of confidence above the threshold level of confidence. The network node 110 may prioritize removing ambiguity before allocating the entire bandwidth, such as 273 RBs, to the retransmission, for example, for efficiency at the network node 110 at the expense of increased latencies.

However, a retransmission in the single RB will likely not change the decoding outcome at the UE 120, such that the UE 120 will still determine to send a NACK. Thus, the retransmission in the single RB allocation in the PDSCH is to generate an uplink response from the UE 120 to remove ambiguity rather than to correct errors. For example, the retransmission may use, a substitute or “dummy” PDSCH transmission for HARQ process CRC state query.

The retransmission may be sent with special MCS to improve the decoding success rate during retransmissions. For example, in HARQ retransmissions, the same TB is transmitted multiple times. However, with special MCS, modulation and code rate may change, such that a lower-order or reduced code rate for retransmissions is used to make the retransmission more robust. For example, using IR HARQ, initial transmissions may be transmitted using a higher-order MCS and subsequent retransmissions may be transmitted using a lower-order MCS, adding robustness through additional coding such that the UE 120 may successfully decode the retransmitted data. In the IR HARQ process, retransmissions may include additional parity bits rather than the entire original data, such as for dynamic MCS adjustment at the RV level.

As previously mentioned, the initial transmission may be transmitted over the PDSCH with RV0. Generally, the RV refers to the specific variation of the encoded bits transmitted for the same packet to enhance reliability during retransmissions, and the IR scheme may include four RVs. The first RV, RV0, is used for the initial transmission and may transmit the codeword, such as systematic bits and some parity bits. The RV1, RV2, and RV3, may be used for retransmissions, where each RV provides a different subset of parity bits to add redundancy. These parity bits complement bits already received by the UE 120 to enhance error correction capabilities. The sequence of RV usage includes RV0 for the initial transmission, and then RV2 for the first retransmission, RV3 for the second retransmission, and RV1 for the third retransmission. This sequence that provides increased diversity of the transmitted bits ensures that the UE 120 receives complementary bits during retransmissions, improving decoding performance.

Since the initial transmission was transmitted over the PDSCH with RV0, the first retransmission has a redundancy of RV2. However, as previously mentioned, this first retransmission over the PDSCH in the single RB to trigger a response from the UE 120 does not impact the decoding at the UE 120, such that the UE 120 will still send a NACK and will not increase HARQ performance. Thus, the retransmission that has a redundancy of RV2 does not contribute to the IR scheme to improve HARQ performance since a subsequent transmission for the purpose of increasing HARQ performance will have a redundancy of RV3 and not RV2, resulting in the initial transmission and the retransmission for correcting errors to increase from RV0 to RV3.

The UE 120 may still determine that the CRC failed. The UE 120 may transmit a signal indicating a NACK over the PUCCH. The network node 110 has confidence, based on the additional NACK, that the UE 120 indicated a NACK and did not properly decode the last transmission. Thus, the network node 110 may transmit a retransmission over PDSCH with the RV3. The network node 110 may transmit the retransmission using the entire bandwidth of 273 RBs since the network node 110 is confident that the feedback message indicated a NACK.

This retransmission and the previous retransmission may be transmitted with special MCS. That is, the MCS may not be explicitly indicated in the retransmissions. The UE 120 may determine the actual MCS index based on a previous indication, predefined rules, configurations, etc. For example, the special MCS may represent an MCS index or configuration defined by the network and provided to the UE 120 during an initial setup, such as the initial transmission. In particular, the network node 110 may provide an indication of a special MCS in subsequent transmissions, such as retransmissions, to avoid transmitting an entire MCS index to reduce channel overhead.

In some cases, the UE 120 may not detect or properly decode the initial transmission. However, the network node 110 may be unaware of whether the first PDSCH transmission, which includes the explicit MCS value, was successfully decoded by the UE 120. Thus, the UE 120 may be unable to determine, such as implicitly determine, the MCS index based on the indication of special MCS in subsequent retransmissions. The network node 110 retransmitting with an indication of the special MCS that the UE 120 cannot use to determine the MCS index be an inefficient usage of the network node 110 and channel resources.

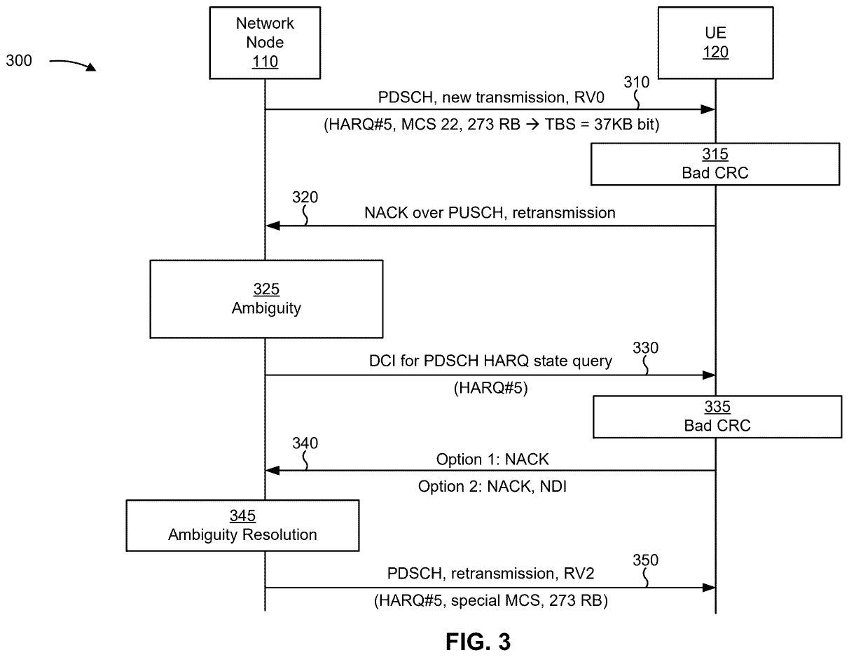

To address the inefficiencies discussed herein, such as allocating the PDSCH (in a single RB) for retransmission to generate HARQ feedback for confidence of prior feedback, inefficiently applying the IR scheme to the retransmission, and the lack of knowledge that the network node 110 has regarding the UE 120 successfully decoding the initial transmission, aspects of this disclosure may operate according to a different flow. One example of which is illustrated in FIG. 3 as using a DCI message to query for the HARQ process state.

FIG. 3 is a diagram illustrating a process flow 300 of an example associated with a HARQ status query, in accordance with the present disclosure. The process flow 300 may implement aspects of or may be implemented by aspects of the wireless communications network 100. For example, the network node 110 and the UE 120 may communicate via a wireless communication network, such as the wireless communication network of FIG. 1. The process flow 300 may include a network node 110, such as a network entity, and a UE 120, such as a wireless node, which may be examples of a network node 110 and a UE 120 as described herein (e.g., FIG. 1).

In the following description of the process flow 300, the operations performed by the network node 110 and the UE 120 may be performed in different orders or at different times than the exemplary order shown. Some operations may also be omitted from the process flow 300, or other operations may be added to the process flow 300. Further, while operations in the process flow 300 are illustrated as being performed by the network node 110 and the UE 120, the examples herein are not to be construed as limiting, as the described features may be associated with any quantity of different devices.

In some examples, at step 310, the network node 110 may transmit a new transmission to the UE 120. For example, the new transmission is transmitted over the PDSCH with a RV0, an MCS index of 22, and a HARQ process ID of HARQ #5 in 273 RBs. At step 315, the UE 120 may not be able to decode the transmission, as previously discussed. For example, the UE 120 may receive the transmission and perform a CRC check, determining that the CRC failed. At step 320, the UE 120 may may transmit a feedback message with an indication of a NACK. For example, at step 320, the UE 120 may transmit a feedback message over the PUSCH indicating a NACK, requesting a retransmission.

At step 325, the network node 110 may determine that the feedback is ambiguous, as previously discussed. For example, the network node 110 may be unaware of whether the feedback signal indicates a NACK, where a level of confidence that the feedback message indicates an ACK or NACK is less than a threshold level of confidence. In some examples, the network node 110 may fail to decode the PUSCH signaling, resulting in unawareness of the HARQ feedback result.

To efficiently request the HARQ process state to confirm feedback results (above a threshold level), at step 330, the network node 110 may send a DCI to the UE 120 to query the HARQ process state. The DCI may include the HARQ ID (HARQ #5) to indicate the particular HARQ process between the network node 110 and the UE 120. That is, rather than sending a retransmission, such as a “fake” or “dummy” retransmission in 1 RB, to generate feedback from the UE 120, the network node 110 may send the DCI that particularly requests the HARQ process state.

The UE 120 may identify the HARQ state, for example, based on the decoding of the initial new transmission at step 310. At step 335, the UE 120 may determine that the CRC failed. At step 340, the UE 120 may send a feedback message or a report with an indication of the NACK (corresponding to the failed CRC state). Additionally, or alternatively, the UE 120 may send an indication of the both the CRC state and the NDI polarity. The NDI polarity may facilitate the network node 110 in realizing whether the initial transmission at step 310 was successfully decoded by the UE 120. An indication of the polarity may be beneficial before the first retransmission.

Accordingly, the DCI includes the HARQ ID of the target HARQ process and an indication of whether an NDI bit is to be reported. In some examples, the DCI for the HARQ process state query may include a PDCCH order or command, such as a PUCCH order, to initiate the HARQ process query, a new DCI type including an identifier bit, or a dedicated bit in DCI.

Regarding the PUCCH order, the DCI may include a command sent by the network node 110 requesting the HARQ process state. The PUCCH order may be similar to an RA order, which is a command from the network node 110 to trigger an RA procedure from the UE 120 for reestablishing synchronization with the network node 110. For example, the PUCCH order may also be a command from the network node to trigger an action at the UE 120, such as to trigger feedback from the UE 120 for increasing HARQ performance and ultimately allow the UE 120 to successful decode. For example, a DCI PDCCH order, such as DCI 1_0 PDCCH order, may be used to initiate the HARQ process state reporting.

Regarding the new DCI type, the DCI may include a new DCI ID bit, which is indicative of the HARQ process state query. The new bit may be padded over the existing DCIs to maintain the same DCI size. Regarding the dedicated DCI bit, the DCI may include a new bit in addition to existing DCIs and the new bit may correspond to the HARQ process state query. Once a bit is set, PDSCH resources may not be valid other than the HARQ process number.

Additionally, or alternatively, the DCI may include an additional bit to request an NDI report, such as an NDI report bit. In some examples, these bits in the DCI may be enabled via RRC configuration.

After receiving the DCI requesting the HARQ process state that may also include an NDI report request (based on the bits in the DCI), the UE 120 may transmit a signal indicating the NACK and/or the NDI bit, based on the DCI. The feedback may be provided over the PUCCH. At step 345, the network node 110 may resolve for the ambiguity based on the indicated states. For example, the network node 110 may identify the state of the HARQ process, as well as identify whether the UE 120 properly decoded the initial transmission based on the NDI bit indication.

At step 350, to correct for errors, the network node 110 may retransmit the transmission over 273 RB in PDSCH with RV2 and special MCS, for example, based on the IR scheme. That is, the network node 110 may retransmit based on the state of the previous transmission with sequential redundancy in PDSCH.

Thus, the techniques described herein address the disadvantages previously discussed, for example, such as retransmitting with PDSCH allocation and/or using special MCS without knowledge of whether the first PDSCH transmission that conveys the MCS and TBS size, was successfully decoded. In particular, the techniques described herein increase resources efficiency for the network node 110 by not using a dummy data allocation for receiving the HARQ process CRC state. The techniques described herein also allow network node 110 to identify whether the initial PDSCH transmission was not decoded by the UE 120. Identify whether the initial PDSCH transmission was not decoded by the UE 120 may provide retransmissions efficiency since subsequent indications of special MCS in retransmissions may not be used by the UE 120 if the UE 120 did not successfully decode the initial transmission that includes the explicit indication of the MCS that is used subsequently for special MCS.

As indicated above, FIG. 3 is provided as an example. Other examples may differ from what is described with regard to FIG. 3.

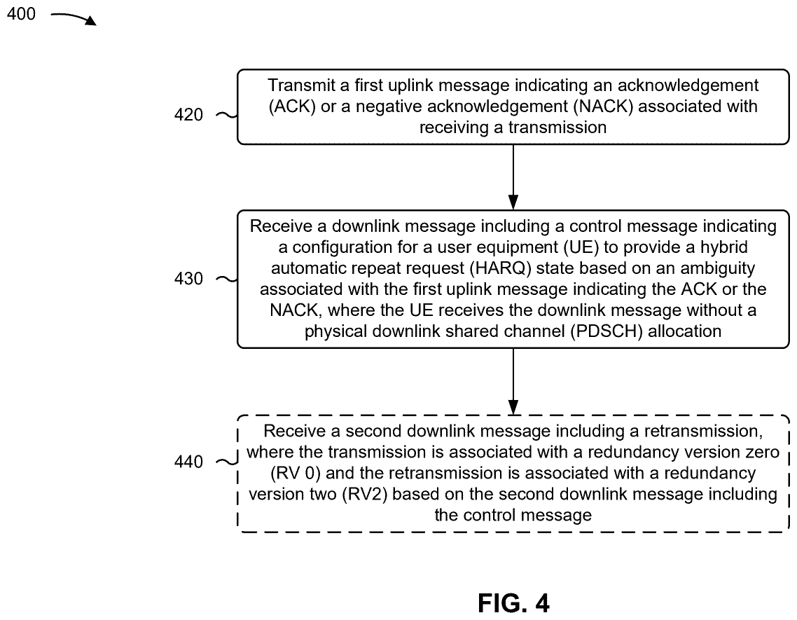

FIG. 4 is a diagram illustrating an example process 400 performed, for example, at a UE 120 or an apparatus of a UE 120, in accordance with the present disclosure. Example process 400 is an example where the apparatus or the UE 120 performs operations associated with providing a HARQ process state in PUCCH upon receiving a DCI (indicating a PUCCH order) querying the HARQ process status.

At step 420, the UE 120 may transmit a first uplink message indicating an ACK or a NACK associated with receiving a transmission. At step 430, the UE 120 may receive a downlink message including a control message indicating a configuration for the UE to provide a HARQ state based on an ambiguity associated with the first uplink message indicating the ACK or the NACK, where the UE receives the downlink message without a PDSCH allocation. In some examples, the ambiguity is associated with a confidence level of the uplink message indicating the ACK or the NACK below a threshold confidence level. In some examples, the second downlink message may include a DCI message communicated over a downlink control channel, such as the PDCCH. In some examples, the control message may include an identifier bit associated with the HARQ state. The identifier bit may be a dedicated bit. In such examples, the control message including the dedicated bit may be padded based on other control messages.

In some examples, the HARQ state may indicate a decoding state of a last transmission, a decoding state of the transmission, or both, where the transmission is indicative of a TBS used for subsequent transmissions. In some examples, the UE 120 may output a second uplink message indicating the HARQ process state, where the second uplink message is communicated over an uplink control channel, such as the PUCCH.

In some examples (as indicated by the dashed line box), at step 440, the UE 120 may receive a second downlink message including a retransmission, where the transmission is associated with RV0 and the retransmission is associated with RV2 based on the second downlink message including the control message. In some examples, the RV level used in the retransmission is selected or determined by the network node. For example, although the retransmission described herein is described with respect to RV2, the network node may select a different RV level. In some examples, the second downlink message includes an indication of an MCS based on a polarity (0 or 1) of an NDI in the second uplink message.

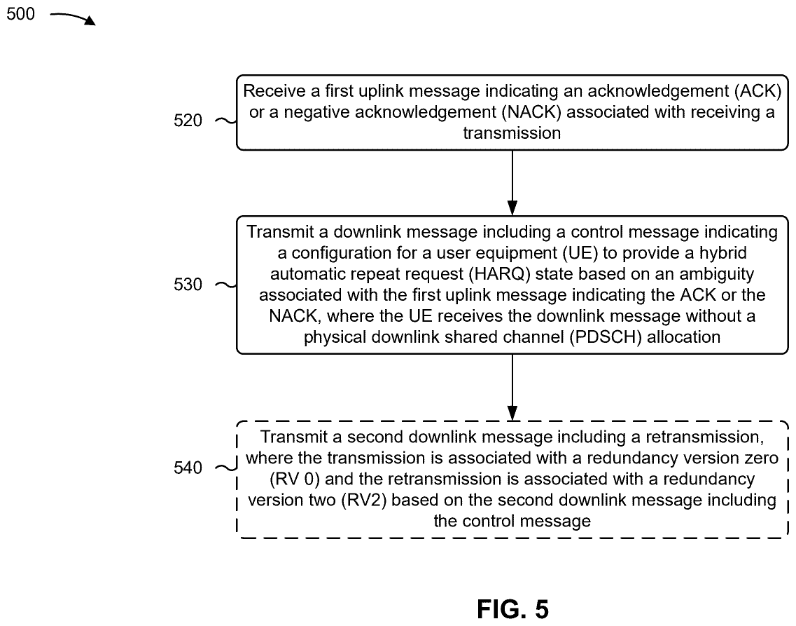

FIG. 5 is a diagram illustrating an example process 500 performed, for example, at a network node 110 or an apparatus of a network, in accordance with the present disclosure. Example process 500 is an example where the apparatus or the network node 110 performs operations associated with requesting a HARQ process status in a DCI, such as DCI including a PUCCH order to initiate the query.

At step 520, the network node 110 may receive a first uplink message indicating an ACK or a NACK associated with receiving a transmission.

At step 530, the network node 110 may transmit a downlink message including a control message, such a DCI, indicating a configuration for a UE to provide a HARQ state based on an ambiguity associated with the first uplink message indicating the ACK or the NACK, wherein the UE receives the downlink message without a PDSCH allocation. In some examples, the wireless node may include a UE.

In some examples, the ambiguity is based on a confidence level that the uplink message indicates the ACK or the NACK below a threshold confidence. For example, the network node 110 may be unaware of whether the feedback first uplink message received indicates a NACK or an ACK. In some examples, the downlink message may include a DCI message communicated over a downlink control channel, such as a PDCCH. In some examples, the network node may receive a second uplink message indicating the HARQ state, the second uplink message communicated over an uplink control channel, such as the PUCCH.

In some examples, the HARQ state may indicate a decoding state of a last transmission, a decoding state of the transmission, or both, where the transmission is indicative of a TBS used for subsequent transmissions. In some examples, the control message may include an identifier bit associated with the HARQ state. The identifier bit may be a dedicated bit, such as a bit dedicated to HARQ process status request, and that is padded based on other control messages.

In some examples (as indicated by the dashed line box), at step 540, the network node 110 may transmit a second downlink message including a retransmission, where the transmission is associated with RV0 and the retransmission is associated with RV2 based on the second downlink message including the control message. In some examples, the RV level used in the retransmission is selected or determined by the network node. For example, although the retransmission described herein is described with respect to RV2, the network node may select a different RV level. In some examples, the second downlink message may include an indication of an MCS scheme based on an NDI in the second uplink message. In some examples, the MCS scheme is based on a polarity of an NDI in the second uplink message from the UE.

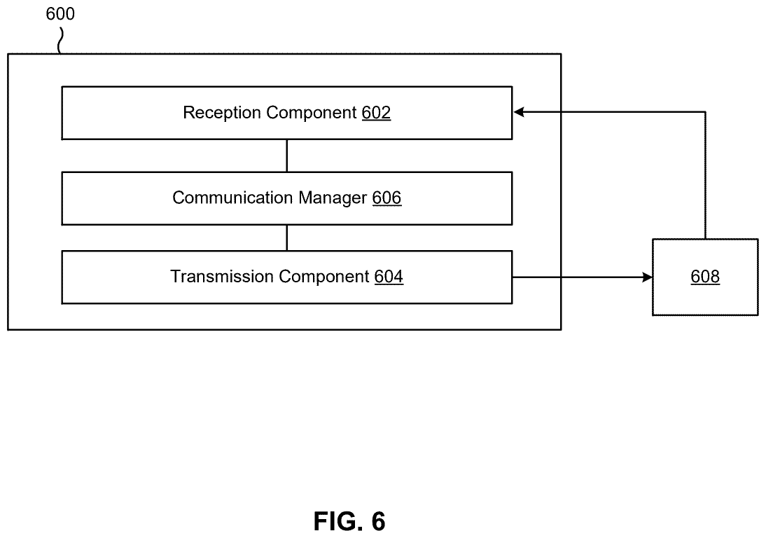

FIG. 6 is a diagram of an example apparatus 600 for wireless communication, in accordance with the present disclosure. The apparatus 600 may be a UE, or a UE may include the apparatus 600. In some aspects, the apparatus 600 includes a reception component 602, a transmission component 604, and/or a communication manager 606, which may be in communication with one another (for example, via one or more buses and/or one or more other components). In some aspects, the communication manager 606 is the communication manager 140 described in connection with FIG. 1. As shown, the apparatus 600 may communicate with another apparatus 608, such as a UE or a network node (such as a CU, a DU, an RU, or a base station), using the reception component 602 and the transmission component 604.

In some aspects, the apparatus 600 may be configured to perform one or more operations described herein in connection with FIGS. 2-5. Additionally, or alternatively, the apparatus 600 may be configured to perform one or more processes described herein, such as process flow 300 of FIG. 3, or a combination thereof. In some aspects, the apparatus 600 and/or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, one or more modems, one or more demodulators, one or more MIMO detectors, one or more receive processors, one or more controllers/processors, one or more memories, or a combination thereof, of the UE described in connection with FIG. 1.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 608. In some aspects, the transmission component 604 may include one or more antennas, one or more modems, one or more modulators, one or more transmit MIMO processors, one or more transmit processors, one or more controllers/processors, one or more memories, or a combination thereof, of the UE described in connection with FIG. 1. In some aspects, the transmission component 604 may be co-located with the reception component 602 in one or more transceivers.

The communication manager 606 may support operations of the reception component 602 and/or the transmission component 604. For example, the communication manager 606 may receive information associated with configuring reception of communications by the reception component 602 and/or transmission of communications by the transmission component 604. Additionally, or alternatively, the communication manager 606 may generate and/or provide control information to the reception component 602 and/or the transmission component 604 to control reception and/or transmission of communications.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, and/or modems, among other examples, such as described in the examples in FIG. 1.

The reception component 602 may obtain a first downlink message including a transmission. The communication manager 606 may generate the feedback control message, as discussed with respect to FIGS. 2-5. The transmission component 604 may also transmit data for transmission via the control channel. For example, the communication manager 606 may generate a first uplink message and the transmission component 604 may transmit the first uplink message, which indicates an ACK or a NACK associated with receiving a transmission.

The reception component 602 may receive a downlink message comprising a control message indicating a configuration for the apparatus to provide a HARQ state based at least in part on an ambiguity associated with the first uplink message indicating the ACK or the NACK, where the UE receives the downlink message without a PDSCH allocation. The transmission component 604 may transmit a second uplink message indicating the HARQ process status, the second uplink message communicated over an uplink control channel. The reception component 602 may receive a second downlink message including a retransmission, where the transmission is associated with RV0 and the retransmission is associated with a RV2 based on the second downlink message comprising the control message.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

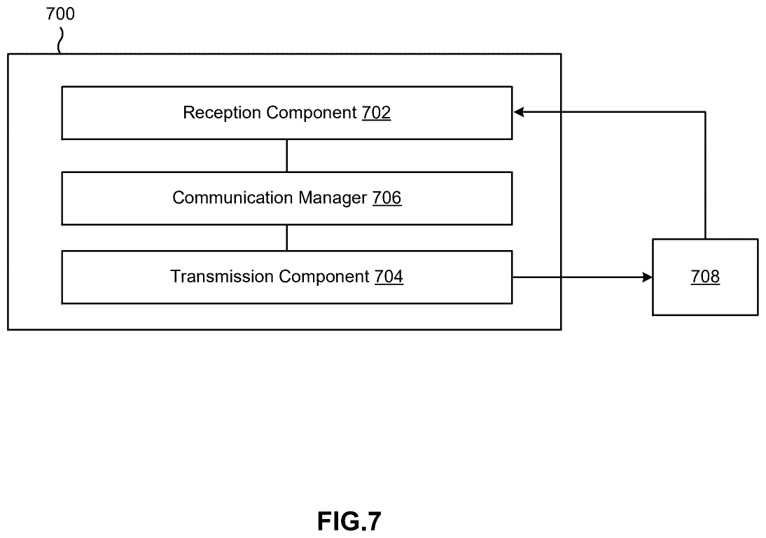

FIG. 7 is a diagram of an example apparatus 700 for wireless communication, in accordance with the present disclosure. The apparatus 700 may be a network node, or a network node may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704.

In some aspects, the apparatus 700 may be configured to perform one or more operations described herein in connection with FIGS. 2-5. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive a first uplink message indicating an ACK or a NACK associated with receiving a transmission. The transmission component 704 may transmit a downlink message indicating a configuration for the UE to provide a HARQ state based on an ambiguity associated with the first uplink message indicating the ACK or the NACK, where the UE receives the downlink message without a PDSCH allocation. In some aspects, the transmission component 704 may transmit a second downlink message including a retransmission, where the transmission is associated with an RV0 and the retransmission is associated with an RV2 based on the second downlink message including the control message. In some aspects, the control message may include an identifier bit associated with the HARQ state and the identifier bit may be a dedicated bit. In such aspects, the communication manager 706 may pad the control message including the dedicated bit based on other control messages.

In some aspects, the reception component 702 may perform deinterleaving, de-mapping, equalization, interference cancellation, or decoding, among other examples), and may provide the processed signals to the one or more other components of the apparatus 700. In some aspects, the reception component 702 may include one or more antennas, one or more modems, one or more demodulators, one or more MIMO detectors, one or more receive processors, one or more controllers/processors, one or more memories, or a combination thereof, of the network node described in connection with FIG. 1. In some aspects, the reception component 702 and/or the transmission component 704 may include or may be included in a network interface. The network interface may be configured to obtain and/or output signals for the apparatus 700 via one or more communications links, such as a backhaul link, a midhaul link, and/or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 704 may include one or more antennas, one or more modems, one or more modulators, one or more transmit MIMO processors, one or more transmit processors, one or more controllers/processors, one or more memories, or a combination thereof, of the network node described in connection with FIG. 1. In some aspects, the transmission component 704 may be co-located with the reception component 702 in one or more transceivers.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, and/or modems, among other examples, such as described in the examples in FIG. 1.

The reception component 702 may receive the one or more DCIs that configure a UE 120 to provide an indication of HARQ process status. The reception component 702 may receive, via the control channel, data, such as user data.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

In a first aspect, a method for wireless communication at a UE includes transmitting a first uplink message indicating an ACK or a NACK associated with receiving a transmission, and receiving a downlink message comprising a control message indicating a configuration for the UE to provide a HARQ state based at least in part on an ambiguity associated with the first uplink message indicating the ACK or the NACK, where the UE receives the downlink message without a PDSCH allocation.

In a second aspect, in combination with the first aspect, the HARQ state indicates a decoding state of a last transmission, a decoding state of the transmission, or both, where the transmission is indicative of a transport block size used for subsequent transmissions.

In a third aspect, in combination with one or more of the first aspect or the second aspect, the ambiguity is associated with a confidence level of the first uplink message indicating the ACK or the NACK below a threshold confidence level.

In a fourth aspect, in combination with one or more of the first aspect through the third aspect, the method includes transmitting a second uplink message indicating the HARQ state, the second uplink message communicated over an uplink control channel.

In a fifth aspect, in combination with one or more of the first aspect through the fourth aspect, the method includes receiving a second downlink message comprising a retransmission, where the transmission is associated with a redundancy version zero (RV0) and the retransmission is associated with a redundancy version two (RV2) based at least in part on the downlink message comprising the control message.

In a sixth aspect, in combination with one or more of the first aspect through the fifth aspect, the second downlink message comprises an indication of a modulation and coding scheme based at least in part on a polarity of a new data indicator in a second uplink message from the UE.

In a seventh aspect, in combination with one or more of the first aspect through the sixth aspect, the downlink message comprises a downlink control information (DCI) message communicated over a downlink control channel.

In an eighth aspect, in combination with one or more of the first aspect through the seventh aspect, the control message comprises an identifier bit associated with the HARQ state.

In a ninth aspect, in combination with one or more of the first aspect through the eighth aspect, the identifier bit is a dedicated bit that is padded based at least in part on other control messages.

In an tenth aspect, a method for wireless communication at a network node includes receiving a first uplink message indicating an ACK or a NACK associated with receiving a transmission, and transmitting a downlink message comprising a control message indicating a configuration for a UE to provide a HARQ state based at least in part on an ambiguity associated with the first uplink message indicating the ACK or the NACK, where the UE receives the downlink message without a PDSCH allocation.

In an eleventh aspect, in combination with the tenth aspect, the HARQ state indicates a decoding state of a last transmission, a decoding state of the transmission, or both, where the transmission is indicative of a transport block size used for subsequent transmissions.

In a twelfth aspect, in combination with the tenth aspect or the eleventh aspect, the ambiguity is based at least in part on a confidence level that the first uplink message indicates the ACK or the NACK below a threshold confidence level.

In a thirteenth aspect, in combination with the tenth aspect through the twelfth aspect, the method includes transmitting a second downlink message comprising a retransmission, where the transmission is associated with a redundancy version zero (RV0) and the retransmission is associated with a redundancy version two (RV2) based at least in part on the downlink message comprising the control message.

In a fourteenth aspect, in combination with the tenth aspect through the thirteenth aspect, the second downlink message comprises an indication of a modulation and coding scheme based at least in part on a polarity of a new data indicator in a second uplink message from the UE.

In a fifteenth aspect, a UE for wireless communications, comprising one or more memories storing processor-executable code, and one or more processors coupled with the one or more memories and individually or collectively operable to execute the code to cause the UE to perform a method of any of aspects 1 through 9.

In a sixteenth aspect, a UE for wireless communications, comprising at least one means for performing a method of any of aspects 1 through 9.

In a seventeenth aspect, a non-transitory computer-readable medium storing code for wireless communications at the UE, the code comprising instructions executable by one or more processors to perform a method of any of aspects 1 through 9.

In an eighteenth aspect, a network node for wireless communications, comprising one or more memories storing processor-executable code, and one or more processors coupled with the one or more memories and individually or collectively operable to execute the code to cause the network node to perform a method of any of aspects 10 through 14.

In a nineteenth aspect, a network node for wireless communications, comprising at least one means for performing a method of any of aspects 10 through 14.

In a twentieth aspect, a non-transitory computer-readable medium storing code for wireless communications at a network node, the code comprising instructions executable by one or more processors to perform a method of any of aspects 10 through 14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

Further, while the present disclosure may describe certain types of communications between different types of wireless nodes, such as between a network node 110 and a UE 120, the same or similar types of communications may occur between same types of wireless nodes, such as between network nodes or between UEs, in a peer-to-peer scenario. Further, communications may occur in reverse order than described.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories comprising instructions; and
one or more processors coupled with the one or more memories and individually or collectively operable to execute the instructions to cause the apparatus to:
transmit a first uplink message indicating an acknowledgement (ACK) or a negative acknowledgement (NACK) associated with receiving a transmission; and
receive a downlink message comprising a control message indicating a configuration for the UE to provide a hybrid automatic repeat request (HARQ) state based at least in part on an ambiguity associated with the first uplink message indicating the ACK or the NACK, wherein the UE receives the downlink message without a physical downlink shared channel (PDSCH) allocation.

2. The apparatus of claim 1, wherein the HARQ state indicates a decoding state of a last transmission, a decoding state of the transmission, or both, wherein the transmission is indicative of a transport block size used for subsequent transmissions.

3. The apparatus of claim 1, wherein the ambiguity is associated with a confidence level of the first uplink message indicating the ACK or the NACK below a threshold confidence level.

4. The apparatus of claim 1, wherein the one or more processors are individually or collectively further operable to execute the instructions to cause the apparatus to:
transmit a second uplink message indicating the HARQ state, the second uplink message communicated over an uplink control channel.

5. The apparatus of claim 1, wherein the one or more processors are individually or collectively further operable to execute the instructions to cause the apparatus to:
receive a second downlink message comprising a retransmission, wherein the transmission is associated with a redundancy version zero (RV0) and the retransmission is associated with a redundancy version two (RV2) based at least in part on the downlink message comprising the control message.

6. The apparatus of claim 5, wherein the second downlink message comprises an indication of a modulation and coding scheme based at least in part on a polarity of a new data indicator in a second uplink message from the UE.

7. The apparatus of claim 1, wherein the downlink message comprises a downlink control information (DCI) message communicated over a downlink control channel.

8. The apparatus of claim 1, wherein the control message comprises an identifier bit associated with the HARQ state.

9. The apparatus of claim 8, wherein the identifier bit is a dedicated bit that is padded based at least in part on other control messages.

10. A method of wireless communication a user equipment (UE), comprising:
transmitting a first uplink message indicating an acknowledgement (ACK) or a negative acknowledgement (NACK) associated with receiving a transmission; and
receiving a downlink message comprising a control message indicating a configuration for the UE to provide a hybrid automatic repeat request (HARQ) state based at least in part on an ambiguity associated with the first uplink message indicating the ACK or the NACK, wherein the UE receives the downlink message without a physical downlink shared channel (PDSCH) allocation.

11. The method of claim 10, wherein the HARQ state indicates a decoding state of a last transmission, a decoding state of the transmission, or both, wherein the transmission is indicative of a transport block size used for subsequent transmissions.

12. The method of claim 10, wherein the ambiguity is based at least in part on a confidence level that the first uplink message indicates the ACK or the NACK below a threshold confidence level.

13. The method of claim 10, comprising:
transmitting a second uplink message indicating the HARQ state, the second uplink message communicated over an uplink control channel.

14. The method of claim 10, comprising:
receiving a second downlink message comprising a retransmission, wherein the transmission is associated with a redundancy version zero (RV0) and the retransmission is associated with a redundancy version two (RV2) based at least in part on the downlink message comprising the control message.

15. The method of claim 14, wherein the second downlink message comprises an indication of a modulation and coding scheme based at least in part on a polarity of a new data indicator in a second uplink message from the UE.

16. An apparatus for wireless communication at a network node, comprising:
one or more memories comprising instructions; and
one or more processors coupled with the one or more memories and individually or collectively operable to execute the instructions to cause the apparatus to:
receive a first uplink message indicating an acknowledgement (ACK) or a negative acknowledgement (NACK) associated with receiving a transmission; and
transmit a downlink message comprising a control message indicating a configuration for a user equipment (UE) to provide a hybrid automatic repeat request (HARQ) state based at least in part on an ambiguity associated with the first uplink message indicating the ACK or the NACK, wherein the UE receives the downlink message without a physical downlink shared channel (PDSCH) allocation.

17. The apparatus of claim 16, wherein the HARQ state indicates a decoding state of a last transmission, a decoding state of the transmission, or both, wherein the transmission is indicative of a transport block size used for subsequent transmissions.

18. The apparatus of claim 16, wherein the ambiguity is based at least in part on a confidence level that the first uplink message indicates the ACK or the NACK below a threshold confidence level.

19. The apparatus of claim 16, wherein the one or more processors are individually or collectively further operable to execute the instructions to cause the apparatus to:
transmit a second downlink message comprising a retransmission, wherein the transmission is associated with a redundancy version zero (RV0) and the retransmission is associated with a redundancy version two (RV2) based at least in part on the downlink message comprising the control message.

20. The apparatus of claim 19, wherein the second downlink message comprises an indication of a modulation and coding scheme based at least in part on a polarity of a new data indicator in a second uplink message from the UE.
